(19) United States
(12) Patent Application Publication
(10) Pub. No.: US 2021/0124039 A1
(43) Pub. Date: Apr. 29, 2021

(54) SECURITY DEVICE, SYSTEM, AND METHOD FOR FORMING VIRTUAL SECURITY SPACE

(71) Applicant: BITSENSING INC., Seoul (KR)

(72) Inventor: Jae Eun LEE, Seoul (KR)

(73) Assignee: BITSENSING INC., Seoul (KR)

(21) Appl. No.: 17/140,621

(22) Filed: Jan. 4, 2021

Related U.S. Application Data
(63) Continuation of application No. PCT/KR2019/007745, filed on Jun. 26, 2019.

(30) Foreign Application Priority Data
Jul. 4, 2018 (KR) 10-2018-0077718

(51) Int. Cl. G01S 13/88; G08B 13/181; H01Q 15/18

(52) U.S. Cl. CPC G01S 13/88; H01Q 15/18; G08B 13/181

(57) ABSTRACT

A security apparatus forms a virtual security area. The security apparatus includes a radar sensor that transmits and receives a signal; and a reflector that reflects a signal output from a radar sensor of another security apparatus adjacent to the security apparatus. The security apparatus transmits a signal to a reflector of the another security apparatus adjacent to the security apparatus and receives a signal reflected by the reflector of the another security apparatus through the radar sensor to form a virtual security area between the security apparatus and the another security apparatus.

### CROSS REFERENCE TO RELATED APPLICATIONS

This application is a continuation of International Application No. PCT/KR2019/007745 filed on Jun. 26, 2019 which claims priority to Korean Patent Application No. 10-2018-0077718 filed on Jul. 4, 2018, the entire contents of which are herein incorporated by reference.

### TECHNICAL FIELD

The present disclosure relates to a security device, system and method for forming a virtual security space.

### BACKGROUND

A security area to which access is strictly forbidden is physically fenced, and guarded or equipped with a surveillance device such as a CCTV or the like. In some cases, an approach to a physical fence may be prohibited, and in some cases, an approach to a specific area without a fence may be prohibited. In recent years, a technique for forming a virtual fence (security) using surveillance laser beams and electromagnetic waves without building a physical fence has been used to monitor trespass of outsiders.

In this regard, Korean Patent No. 10-1507238, which is one of prior arts, discloses a radar apparatus that forms a virtual fence.

However, if surveillance laser beams are used for forming a virtual fence without building a physical fence, the probability of misdetection by light of laser beams may increase due to environmental factors such as dust, fog and rain. Therefore, the surveillance laser beams are not suitable for application to outdoor security areas.

If electromagnetic waves are used for forming a virtual fence, the electromagnetic waves propagate radially beyond a predetermined security area. Therefore, the extent of security area extends and misdetection occurs.

### SUMMARY

### Problems to be Solved by the Invention

In view of the foregoing, the present disclosure provides a security apparatus and method for forming a virtual security area using a plurality of security apparatuses installed around a protection area. The present disclosure provides a security apparatus and method for forming a virtual security area, including transmitting a signal from the security apparatus to another security apparatus, receiving a signal reflected from the another security apparatus, and determining whether or not an outsider has trespassed based on the received reflection data. The present disclosure provides a security apparatus and method for forming a virtual security area, including forming a plurality of virtual security areas using a plurality of security apparatuses, which enables the construction of an unmanned security system. The problems to be solved by the present disclosure are not limited to the above-described problems. There may be other problems to be solved by the present disclosure.

### Means for Solving the Problems

According to an exemplary embodiment, a security apparatus that forms a virtual security area may include a radar sensor that transmits and receives a signal; and a reflector that reflects a signal output from a radar sensor of another security apparatus adjacent to the security apparatus, wherein the security apparatus transmits a signal to a reflector of the another security apparatus adjacent to the security apparatus and receives a signal reflected by the reflector of the another security apparatus through the radar sensor to form a virtual security area between the security apparatus and the another security apparatus.

According to another exemplary embodiment, a security system may include a plurality of security apparatuses that forms a virtual security area, wherein each security apparatus includes a radar sensor that transmits and receives a signal and a reflector that reflects a signal output from a radar sensor of another security apparatus adjacent to the security apparatus, and the plurality of security apparatuses include at least a first security apparatus, a second security apparatus and a third security apparatus, and a radar sensor of the first security apparatus transmits a signal to a reflector of the second security apparatus adjacent to the first security apparatus and receives a signal reflected by the reflector of the second security apparatus, and a reflector of the first security apparatus receives a signal transmitted from a radar sensor of the third security apparatus adjacent to the first security apparatus and reflects the received signal to the radar sensor of the third security apparatus, and the first security apparatus, the second security apparatus and the third security apparatus form a virtual security area among the first security apparatus, the second security apparatus and the third security apparatus by transmitting and receiving a signal.

According to another exemplary embodiment, a method for forming a virtual security area by a security apparatus including a radar sensor that transmits and receives a signal and a reflector that reflects a signal output from an external device may include transmitting a signal to a reflector of another security apparatus adjacent to the security apparatus through the radar sensor; receiving a signal reflected by the reflector of the another security apparatus through the radar sensor; and forming a virtual security area between the security apparatus and the another security apparatus by transmitting and receiving the signal.

The above-described exemplary embodiments are provided by way of illustration only and should not be construed as liming the present disclosure. Besides the above-described exemplary embodiments, there may be additional exemplary embodiments described in the accompanying drawings and the detailed description.

### Effects of the Invention

According to the present disclosure, it is possible to provide a security apparatus and method for forming a virtual security area using a plurality of security apparatuses installed around a protection area. Also, it is possible to provide a security apparatus and method for forming a virtual security area, including transmitting a signal from the security apparatus to another security apparatus, receiving a signal reflected from the another security apparatus, and determining whether or not an outsider has trespassed based on the received reflection data. Further, it is possible to provide a security apparatus and method for forming a virtual security area, including forming a plurality of virtual security areas using a plurality of security apparatuses, which enables the construction of an unmanned security system.

### BRIEF DESCRIPTION OF THE DRAWINGS

FIG. 1A illustrates the configuration of a security apparatus in accordance with an embodiment of the present disclosure.

FIG. 1B illustrates the configuration of a security apparatus in accordance with an embodiment of the present disclosure.

FIG. 2A is an example depiction to explain a process of transmitting and receiving a signal between a radar sensor and a reflector in accordance with an embodiment of the present disclosure.

FIG. 2B is an example depiction to explain a process of transmitting and receiving a signal between a radar sensor and a reflector in accordance with an embodiment of the present disclosure.

FIG. 3 is an example depiction illustrating a virtual security area formed by a security apparatus and another security apparatus in accordance with an embodiment of the present disclosure.

FIG. 4A is an example depiction illustrating measured reflection data in accordance with an embodiment of the present disclosure.

FIG. 4B is an example depiction illustrating measured reflection data in accordance with an embodiment of the present disclosure.

FIG. 4C is an example depiction illustrating measured reflection data in accordance with an embodiment of the present disclosure.

FIG. 4D is an example depiction illustrating measured reflection data in accordance with an embodiment of the present disclosure.

FIG. 4E is an example depiction illustrating measured reflection data in accordance with an embodiment of the present disclosure.

FIG. 4F is an example depiction illustrating measured reflection data in accordance with an embodiment of the present disclosure.

FIG. 5 is a flowchart showing a method for forming a virtual security area by a security apparatus in accordance with an embodiment of the present disclosure.

FIG. 6 is an example depiction to explain a process of forming a virtual security area by a plurality of security apparatuses in accordance with an embodiment of the present disclosure.

FIG. 7 is an example depiction illustrating a virtual security area formed by a plurality of security apparatuses in accordance with an embodiment of the present disclosure.

### DETAILED DESCRIPTION

Hereafter, example embodiments will be described in detail with reference to the accompanying drawings so that the present disclosure may be readily implemented by those skilled in the art. However, it is to be noted that the present disclosure is not limited to the example embodiments but can be embodied in various other ways. In the drawings, parts irrelevant to the description are omitted for the simplicity of explanation, and like reference numerals denote like parts through the whole document.

Throughout this document, the term “connected to” may be used to designate a connection or coupling of one element to another element and includes both an element being “directly connected” another element and an element being “electronically connected” to another element via another element. Further, it is to be understood that the term “comprises or includes” and/or “comprising or including” used in the document means that one or more other components, steps, operation and/or the existence or addition of elements are not excluded from the described components, steps, operation and/or elements unless context dictates otherwise; and is not intended to preclude the possibility that one or more other features, numbers, steps, operations, components, parts, or combinations thereof may exist or may be added.

Throughout this document, the term “unit” includes a unit implemented by hardware and/or a unit implemented by software. As examples only, one unit may be implemented by two or more pieces of hardware or two or more units may be implemented by one piece of hardware.

In the present specification, some of operations or functions described as being performed by a device may be performed by a server connected to the device. Likewise, some of operations or functions described as being performed by a server may be performed by a device connected to the server.

Hereinafter, the present disclosure will be explained in detail with reference to the accompanying configuration views or process flowcharts.

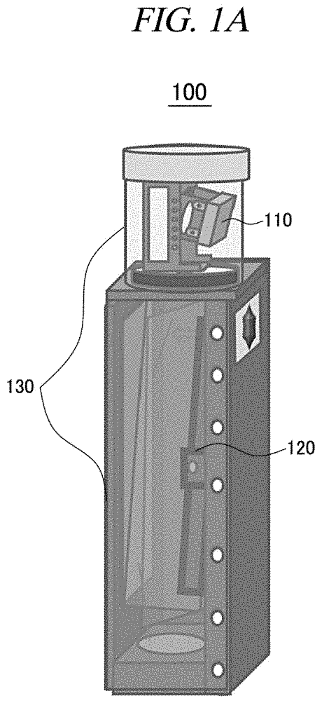

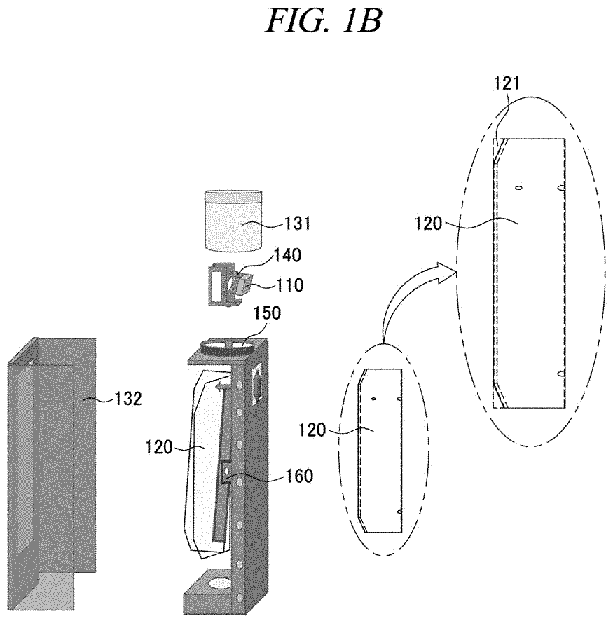

FIG. 1A and FIG. 1B illustrate the configuration of a security apparatus in accordance with an embodiment of the present disclosure.

FIG. 1A illustrates the exterior of a security apparatus in accordance with an embodiment of the present disclosure and FIG. 1B illustrates the configuration of the security apparatus in accordance with an embodiment of the present disclosure. Referring to FIG. 1A and FIG. 1B, a security apparatus 100 may include a radar sensor 110, a reflector 120, a case 130, a first bracket 140, a second bracket 150 and an angle adjuster 160.

The radar sensor 110 may transmit and receive a radar signal.

The reflector 120 may reflect a signal output from a radar sensor of another security apparatus adjacent to the security apparatus 100. The another security apparatus may be manufactured to have the same structure as the security apparatus 100. The reflector 120 may have, for example, a faceted cylinder shape from which at least one side surface has been removed and may receive a signal through a part with the side surface removed. Further, the reflector 120 may include, for example, at least two reflecting members, and adjacent reflecting members among the at least two reflecting members may be bonded to each other to share one edge. Furthermore, the outermost reflecting member among the at least two reflecting members may have an edge which is not shared with another reflecting member and from which a part has been removed. If the security apparatus 100 and another security apparatus are installed in a security area, the reflector 120 of the security apparatus 100 may need to be adjusted in angle in a pitch direction to face a radar sensor of the another security apparatus. Also, a part 121 of the edge may be removed to secure an angle adjusting range of the reflector 120. For example, the removed part 121 may have a triangular shape or a fan shape, but may not be limited thereto.

For example, when the security apparatus 100 and another security apparatus are installed to form a virtual security area, the radar sensor of the security apparatus 100 is installed to face a reflector of the another security apparatus by using a laser beam or a laser range finder and the distance between the security apparatus 100 and the another security apparatus are measured with a laser range finder or a tape measure.

After the another security apparatus is fixed in a horizontal direction of the security apparatus 100, the radar sensor 110 of the security apparatus 100 is rotated in the horizontal direction (yaw direction) to search a position with a signal of the maximum value and then rotated in the opposite direction to match the intensity of the signal with the maximum value and re-search the maximum value. Here, if the maximum value of the signal is equal to or higher than a reference value, the radar sensor 110 of the security apparatus 100 may be fixed in the horizontal direction.

Also, the reflector of the another security apparatus is rotated in a vertical direction (roll direction) to search a position with a signal of the maximum value and then rotated in the opposite direction to match the intensity of the signal with the maximum value and re-search the maximum value. Here, if the maximum value of the signal is equal to or higher than a reference value, the reflector of the another security apparatus may be fixed.

The case 130 may be equipped with the radar sensor 110 and the reflector 120 therein. The case 130 may include at least one surface formed of, for example, a radio wave transmitting material so that a signal can be transmitted well between the radar sensor 110 of the security apparatus 100 and the reflector 120 of the another security apparatus. Also, the case 130 may be configured with a first case 131 having a cylinder shape and a second case 132 having a faceted cylinder shape to separately house the radar sensor 110 and the reflector 120. The radio wave transmitting material may include, for example, ABS (Acrylonitrile Butadiene Styrene), PBT (Poly Butylene Terephthalate) or the like.

The first bracket 140 may adjust the angle of the radar sensor 110 in a height direction of the security apparatus 100 so that the security apparatus 100 can regulate the amount of signals to be reflected by the reflector of the another security apparatus.

The second bracket 150 may adjust the angle of the radar sensor 110 in the horizontal direction of the security apparatus 100 so that the radar sensor 110 of the security apparatus 100 can be positioned to face the reflector of the another security apparatus.

The angle adjuster 160 may be installed on the back of the reflector 120 of the security apparatus 100 to adjust the angle of the reflector 120 in the height direction of the security apparatus 100.

In the security apparatus 100, the radar sensor 110 and the reflector 120 are stacked and installed in a height direction of the case 130 and a signal may be transmitted and received through at least one side surface formed of an electromagnetic wave transmitting material among a plurality of side surfaces of the case 130.

The security apparatus 100 may form a virtual security area between the security apparatus 100 and the another security apparatus by transmitting a signal to the reflector of the another security apparatus adjacent to the security apparatus 100 and receiving a signal reflected by the reflector of the another security apparatus through the radar sensor 110.

As such, the virtual security area is implemented using the radar sensor 110 of the security apparatus 100 and the reflector 120, and, thus, only electromagnetic waves traveling straight through the reflector 120 in spite of the scattering of electromagnetic waves transmitted by the radar sensor 110 are reflected and the reflection of the electromagnetic waves is measured. Therefore, a border of a straight area may be set up, and even when trespass occurs in an area which is out of the straight area but to which electromagnetic waves scatter, the radar sensor 110 do not perform detection of the trespass and thus do not generate an alarm.

Specifically, some of electromagnetic waves propagating radially from the radar sensor 110 of the security apparatus 100 reach the reflector 120 and are reflected by the reflector 120, and the electromagnetic waves reflected by the reflector 120 travel straight toward the radar sensor 110. Here, the scattering of electromagnetic waves occurs, but some of the electromagnetic waves which reach an antenna and whose reflection is measured reach in a straight line.

Accordingly, if trespass occurs in the straight area, the radar sensor 110 with remarkably reduced reflection of received signals may determine that trespass occurs in the virtual security area. However, if a person, an animal or an object is located out of the straight area between the reflector 120 and the radar sensor 110, the presence of electromagnetic waves does not affect the reflection received by the radar sensor 110, and, thus, it is not considered trespass. Therefore, misdetection which has occurred when using surveillance laser beams does not occur in a free area out of the straight virtual security area.

Although not illustrated in FIG. 1A and FIG. 1B, a measurement unit that measures reflection data of a received signal transmitted by the radar sensor 110 and then reflected by the reflector of the another security apparatus may be included in the security apparatus 100. The measurement unit (not illustrated) may transmit the measured reflection data to a trespass detection server. Here, the trespass detection server may determine whether or not an outsider has trespassed on the virtual security area formed between the security apparatus 100 and the another security apparatus based on the measured reflection data.

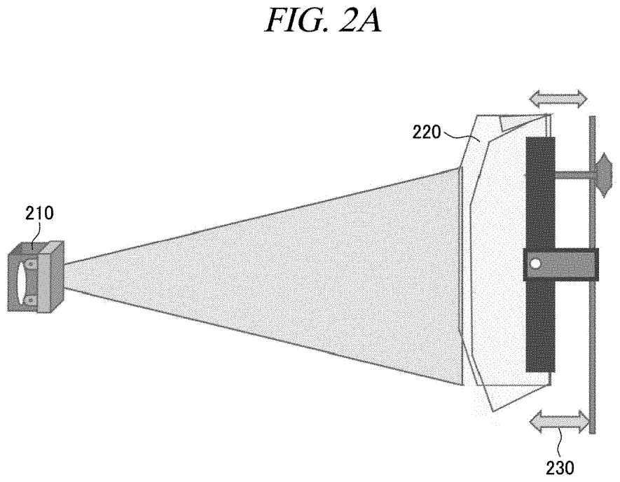

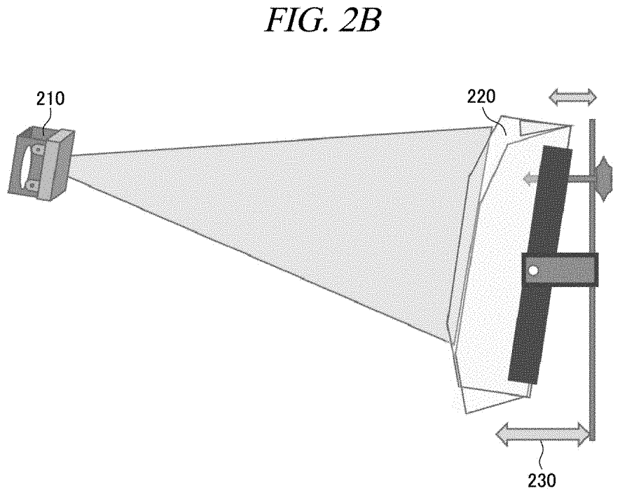

Also, although not illustrated in FIG. 1A and FIG. 1B, an output unit that outputs an audiovisual warning message based on the measured reflection data may be further included in the security apparatus 100. To this end, in the security apparatus 100, the case 130 including the radar sensor 110 may be equipped with a light, a flashing light, a siren, a heating element or the like and may be configured to output a contact signal for directly controlling the light, the flashing light or the siren via TCP/IP communication, RS485 communication, Wi-Fi communication, 3G, 4G, 5G communication, Bluetooth communication, infrared communication, ultrasonic communication, VLC (Visible Light Communication), LiFi and the like. FIG. 2A and FIG. 2B are example depictions to explain a process of transmitting and receiving a signal between a radar sensor and a reflector in accordance with an embodiment of the present disclosure.

FIG. 2A is an example depiction to explain a process of transmitting and receiving a signal when a security apparatus and another security apparatus are installed in a horizontal area in accordance with an embodiment of the present disclosure. Referring to FIG. 2A, if a security apparatus and another security apparatus are installed in a horizontal area, a plane of a radar sensor 210 of the security apparatus may be positioned to be parallel to a plane of a reflector 220 of the another security apparatus to maximize the reflection.

In this case, the reflector 220 has a triangular prism shape with one surface removed, and the reflector 220 may be adjusted to be parallel 230 to a case in the horizontal area.

FIG. 2B is an example depiction to explain a process of transmitting and receiving a signal when the security apparatus and the another security apparatus are installed in a sloping area in accordance with an embodiment of the present disclosure. Referring to FIG. 2B, if the security apparatus and the another security apparatus are installed in a sloping area, the plane of the radar sensor 210 of the security apparatus may be positioned to be parallel as much as much as possible to the plane of the reflector 220 of the another security apparatus by adjusting an orientation angle of the radar sensor 210 of the security apparatus and an orientation angle of the reflector 220 of the another security apparatus to maximize the reflection.

Here, the reflector 220 may be manually or automatically adjusted in angle in a pitch direction in the security area, and the reflector 220 may be positioned to be parallel 230 to the case in the sloping area by decreasing an upper distance between the reflector 220 and the case and increasing a lower distance therebetween to maximize the reflection.

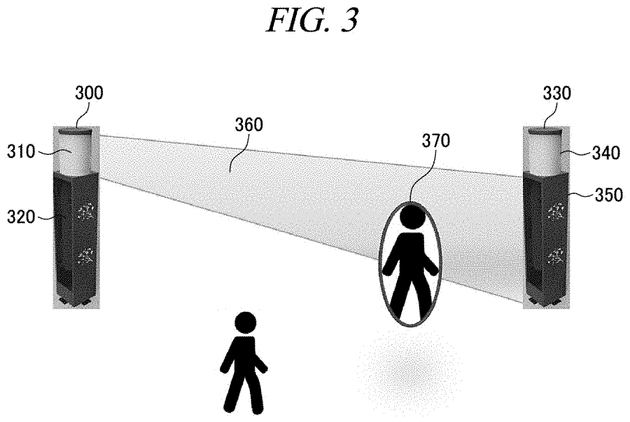

FIG. 3 is an example depiction illustrating a virtual security area formed by a security apparatus and another security apparatus in accordance with an embodiment of the present disclosure. Referring to FIG. 3, a security apparatus 300 and another security apparatus 330 may include radar sensors 310 and 340 and reflectors 320 and 350, respectively.

When the security apparatus 300 transmits a signal through the radar sensor 310, the reflector 350 of the another security apparatus 330 may reflect the signal.

The security apparatus 300 may receive the signal reflected by the reflector 350 of the another security apparatus 330 to form a virtual security area 360 between the security apparatus 300 and the another security apparatus 330.

For example, if an outsider 370 trespasses on the virtual security area 360 formed between the security apparatus 300 and the another security apparatus 330, the security apparatus 300 may measure reflection data of the signal transmitted by the radar sensor 310 and then reflected by the reflector 350 of the another security apparatus 330.

The security apparatus 300 may transmit the measured reflection data to a trespass detection server, and the trespass detection server may determine whether or not an outsider has trespassed on the virtual security area formed between the security apparatus 300 and the another security apparatus 330. Here, if the trespass detection server determines that an outsider has trespassed, the security apparatus 300 may output an audiovisual warning message.

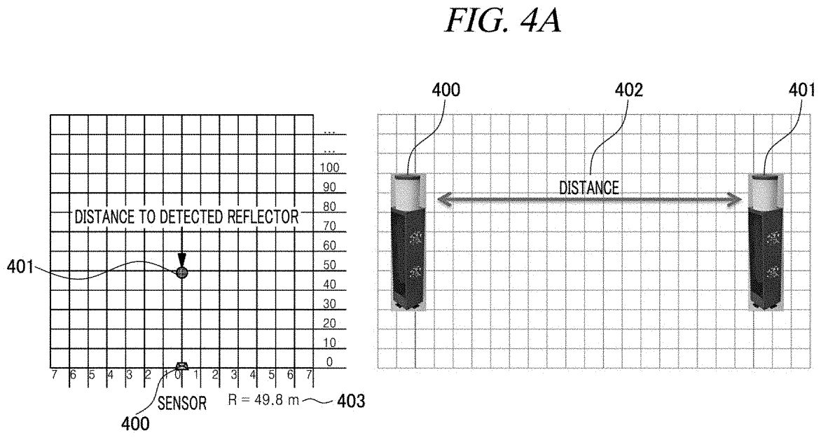

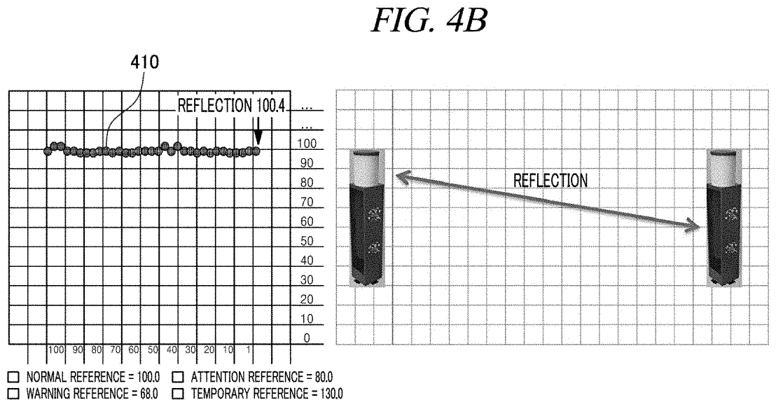

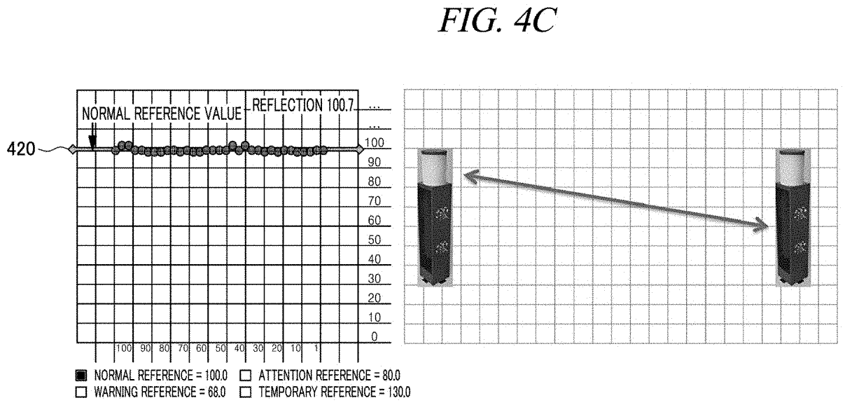

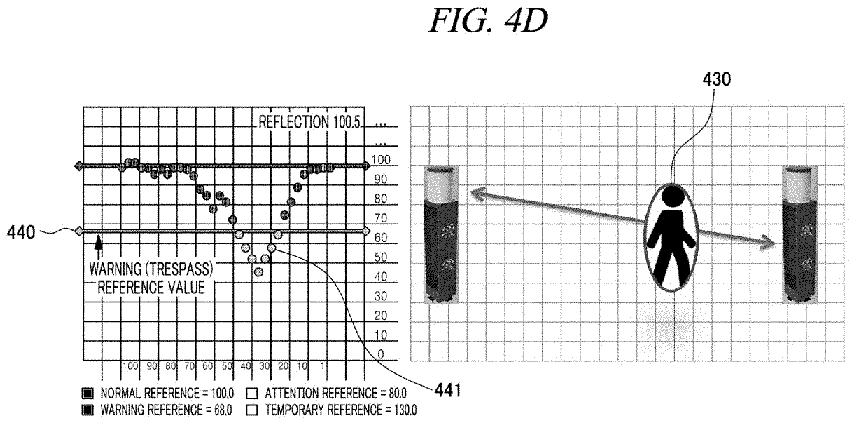

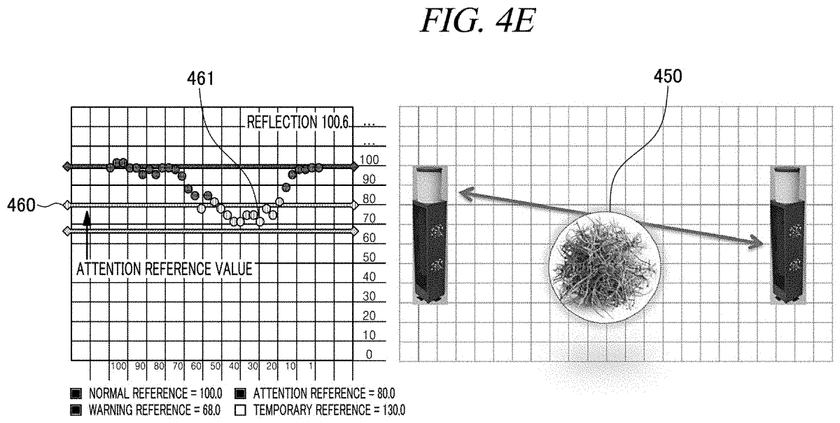

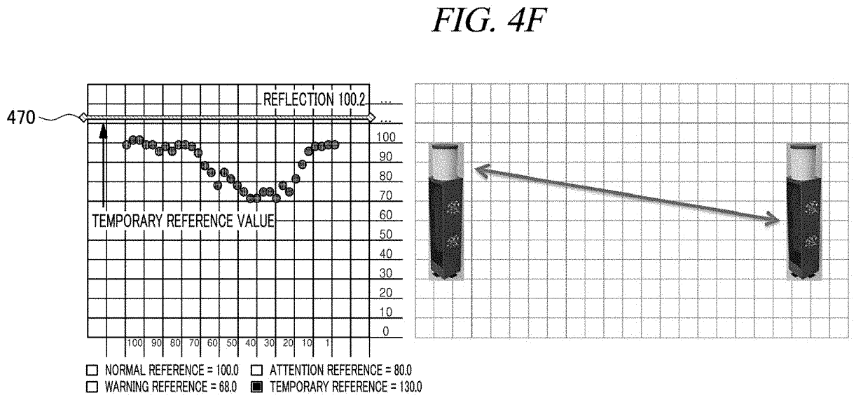

FIG. 4A to FIG. 4F are example depictions illustrating measured reflection data in accordance with an embodiment of the present disclosure.

FIG. 4A is an example depiction illustrating the distance between a security apparatus and another security apparatus in accordance with an embodiment of the present disclosure. Referring to FIG. 4A, a security apparatus 400 may detect a distance 402 to a reflector of another security apparatus 401. For example, if the detected distance 402 to the reflector of another security apparatus 401 is 49.8 m 403, the security apparatus 400 may display that the reflector of the another security apparatus 401 is located at a point corresponding to the distance 402 of 49.8 m 403 on a graph.

FIG. 4B is an example depiction illustrating reflection data received by the security apparatus from the another security apparatus in accordance with an embodiment of the present disclosure. Referring to FIG. 4A and FIG. 4B, the security apparatus 400 may measure reflection data 410 of a signal transmitted by a radar sensor and then reflected from the another security apparatus 401 and display the measured reflection data on a scatter plot. The X-axis of the scatter plot represents time set in a predetermined time unit (with increments of 1, for example, from 0 to 100 which can be changed), and the current time corresponds to 0 on the X-axis and as the value on the X-axis increases, time goes further back. The Y-axis of the scatter plot represents the value of reflection which starts at 0.0 and goes to 10.0 . . . 200.0 with increments of 10.

For example, if the value on the X-axis is “1” and the value of reflection is 100.4, the value of reflection can be displayed at a point where “1” on the X-axis of the scatter plot and “100.4” on the Y-axis intersect.

FIG. 4C is an example depiction illustrating a reference value for normal times set on a scatter plot in accordance with an embodiment of the present disclosure. Referring to FIG. 4A to FIG. 4C, after an adjustment for a horizontal or sloping area between a radar sensor of the security apparatus 400 and a reflector of the another security apparatus 401 is completed, a reference value of reflection for normal times may be set by a manager.

A normal reference value 420 is displayed as a straight line, and the manager may set the normal reference value 420 displayed as a straight line by adjusting the normal reference value 420 with a mouse or inputting a separate value. For example, the manager may set the normal reference value 420 to “100”. Also, the manager may determine whether or not to use the normal reference value 420.

For example, if the normal reference value 420 is “100” and the value of reflection received by the security apparatus 400 is approximate to the normal reference value 420, it may be determined that the virtual security area is currently in normal times.

FIG. 4D is an example depiction illustrating a reference value for warning set on a scatter plot in accordance with an embodiment of the present disclosure. Referring to FIG. 4A to FIG. 4D, after an adjustment for the horizontal or sloping area between the radar sensor of the security apparatus 400 and the reflector of the another security apparatus 401 is completed, a reference value of reflection for warning (trespass) may be set by the manager.

A warning reference value 440 is displayed as a straight line, and the manager may set the warning reference value 440 displayed as a straight line by adjusting the warning reference value 440 with a mouse or inputting a separate value. For example, the manager may set the warning reference value 440 to “68.0”. Also, the manager may determine whether or not to use the warning reference value 440.

For example, if a person or object 430 trespasses on the virtual security area formed between the radar sensor of the security apparatus 400 and the reflector of the another security apparatus 401, the value of reflection is changed, and when a reflection value 441 is measured equal to or lower than the warning reference value 440, the security apparatus 400 may determine that the virtual security area is in a warning sate and output a warning alarm on a screen or by sound.

FIG. 4E is an example depiction illustrating a reference value for attention set on a scatter plot in accordance with an embodiment of the present disclosure. Referring to FIG. 4A to FIG. 4E, after an adjustment for the horizontal or sloping area between the radar sensor of the security apparatus 400 and the reflector of the another security apparatus 401 is completed, a reference value of reflection for attention may be set by the manager.

An attention reference value 460 is displayed as a straight line, and the manager may set the attention reference value 460 displayed as a straight line by adjusting the attention reference value 460 with a mouse or inputting a separate value. For example, the manager may set the attention reference value 460 to “80”. Also, the manager may determine whether or not to use the attention reference value 460.

For example, if the person or object 430 trespasses on the virtual security area formed between the radar sensor of the security apparatus 400 and the reflector of the another security apparatus 401, the value of reflection is changed, and when a reflection value 461 is measured equal to or lower than the attention reference value 460, the security apparatus 400 may determine that the virtual security area is in an attention sate and output an attention alarm indicating a change in reflection value on a screen.

FIG. 4F is an example depiction illustrating a temporary reference value set on a scatter plot in accordance with an embodiment of the present disclosure e. Referring to FIG. 4F, after an adjustment for the horizontal or sloping area between the radar sensor of the security apparatus 400 and the reflector of the another security apparatus 401 is completed, a temporary reference value of reflection may be set by the manager.

A temporary reference value 470 is displayed as a straight line, and the manager may set the temporary reference value 470 displayed as a straight line by adjusting the temporary reference value 470 with a mouse or inputting a separate value. For example, the manager may set the temporary reference value 470 to “130”. Also, the manager may determine whether or not to use the temporary reference value 470.

For example, the temporary reference value 470 may be used when the security apparatus 400 is installed or when the angle between the radar sensor of the security apparatus 400 and the reflector of the another security apparatus 401 is adjusted.

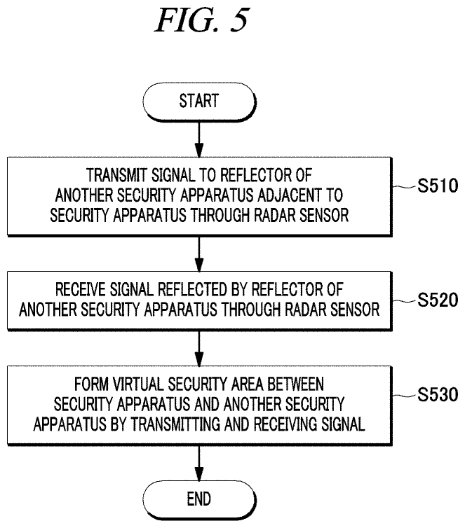

FIG. 5 is a flowchart showing a method for forming a virtual security area by a security apparatus in accordance with an embodiment of the present disclosure. The method for forming a virtual security area by the security apparatus 100 illustrated in FIG. 5 includes the processes time-sequentially performed by the security apparatus 100 according to the embodiment illustrated in FIG. 1A to FIG. 4F. Therefore, descriptions of the processes performed by the security apparatus 100 may also be applied to the method for forming a virtual security area by the security apparatus 100 according to the embodiment illustrated in FIG. 1A to FIG. 4F, even though they are omitted hereinafter.

In a process S510, the security apparatus 100 may transmit a signal to a reflector of another security apparatus adjacent to the security apparatus 100 through the radar sensor.

In a process S520, the security apparatus 100 may receive a signal reflected by the reflector of the another security apparatus through the radar sensor.

In a process S530, the security apparatus 100 may form a virtual security area between the security apparatus 100 and the another security apparatus by transmitting and receiving a signal.

In the descriptions above, the processes S510 to S530 may be divided into additional processes or combined into fewer processes depending on an exemplary embodiment. In addition, some of the processes may be omitted and the sequence of the processes may be changed if necessary.

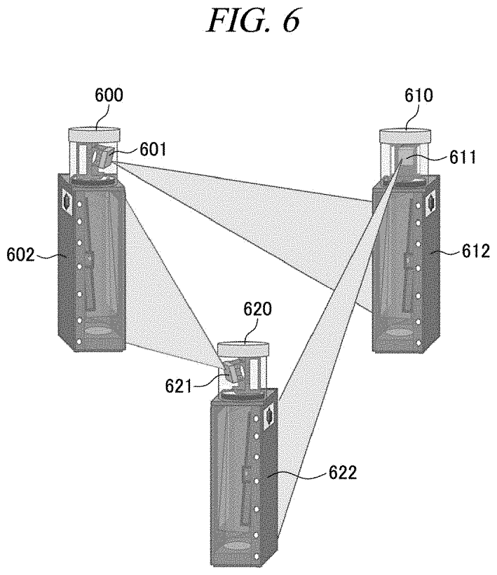

FIG. 6 is an example depiction to explain a process of forming a virtual security area by a plurality of security apparatuses in accordance with an embodiment of the present disclosure. Referring to FIG. 6, a plurality of security apparatuses may include a first security apparatus 600, a second security apparatus 610 and a third security apparatus 620 and may be arranged at a predetermined interval around a protection area. Here, the plurality of security apparatuses may include radar sensors 601, 611 and 621 configured to transmit and receive a signal and reflectors 602, 612 and 622 configured to reflect a signal reflected by a radar sensor of another security apparatus adjacent thereto, respectively.

For example, the radar sensor 601 of the first security apparatus 600 may transmit a signal to the reflector 612 of the second security apparatus 610 adjacent to the first security apparatus 600 and receive a signal reflected by the reflector 612 of the second security apparatus 610. Also, the reflector 602 of the first security apparatus 600 may receive a signal transmitted from the radar sensor 621 of the third security apparatus 620 adjacent to the first security apparatus 600 and reflect a signal to the radar sensor 621 of the third security apparatus 620.

As such, the first security apparatus 600, the second security apparatus 610 and the third security apparatus 620 form a virtual security area among the first security apparatus 600, the second security apparatus 610 and the third security apparatus 620 by transmitting and receiving a signal. Thus, a closed loop enclosing the protection area may be formed by a plurality of virtual security areas each formed between adjacent security apparatuses among the plurality of security apparatuses. FIG. 6 illustrates that three security apparatuses are arranged to form a triangular closed loop, but the present disclosure is not limited thereto. The shape of the closed loop just needs to cover the entire surface of the protection area.

Although not illustrated in FIG. 6, measurement units and determination units may be further included in the respective plurality of security apparatuses in addition to the radar sensors 601, 611 and 621 and the reflectors 602, 612 and 622.

The measurement units may measure reflection data of received signals respectively transmitted by the radar sensors of the plurality of security apparatuses and then reflected by the reflectors of the plurality of security apparatuses.

The determination units may determine whether or not an outsider has trespassed on the plurality of virtual security areas enclosing the protection area based on the measured reflection data.

If the determination units determine that an outsider has trespassed on any one of the plurality of virtual security areas, the determination units may estimate that the outsider is located between adjacent security apparatuses that form the virtual security area on which the outsider has trespassed.

That is, the protection area is enclosed by the closed loop including the plurality of security areas formed among the plurality of security apparatuses, and, thus, it is possible to determine whether or not an outsider has trespassed on the plurality of security areas and also possible to output an alarm to suppress a trespass of an outsider or notify the manager of a trespass of an outsider.

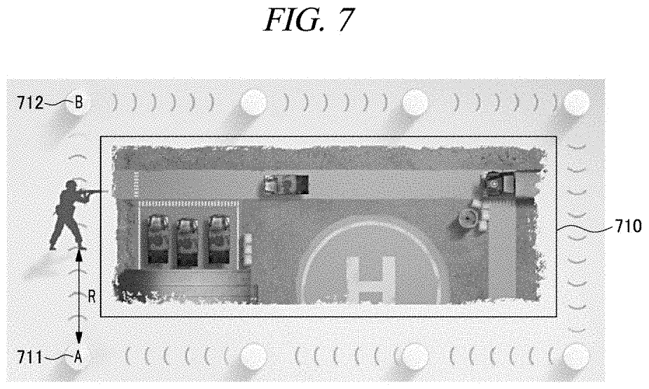

FIG. 7 is an example depiction illustrating a virtual security area formed by a plurality of security apparatuses in accordance with an embodiment of the present disclosure. Referring to FIG. 7, a plurality of security apparatuses may be arranged at a predetermined interval around a protection area 700, and, thus, a closed loop enclosing the protection area 700 may be formed by a plurality of virtual security areas each formed between adjacent security apparatuses among the plurality of security apparatuses. Therefore, it is possible to construct an unmanned security system.

For example, if an outsider trespasses on an area between an apparatus A 711 and an apparatus B 712, the flow of signals is impeded by the outsider, and, thus, a virtual security area formed between the apparatus A 711 and the apparatus B 712 may be blocked. The apparatus A 711 may generate a warning alarm as the intensity of a signal reflected by a reflector of the apparatus B 712 and then received by a radar sensor of the apparatus A 711 becomes lower than a threshold value. Here, the apparatus A 711 may estimate that the outsider is located between the apparatus A 711 and the apparatus B 712 and measured the distance to an object detected by the radar sensor of the apparatus A 711. For example, the apparatus A 711 may measure a distance R from the apparatus A 711 to the outsider based on the intensity of the received signal and thus more accurately estimate a position of the outsider.

The method for forming a virtual security area by a security apparatus including a radar sensor configured to transmit and receive a signal and a reflector configured to reflect a signal output from an external device as described above with reference to FIG. 1A to FIG. 7 can be implemented in a computer program stored in a medium to be executed by a computer or a storage medium including instructions codes executable by a computer. Also, the method for forming a virtual security area by a security apparatus including a radar sensor configured to transmit and receive a signal and a reflector configured to reflect a signal output from an external device as described above with reference to FIG. 1A to FIG. 7 can be implemented in a computer program stored in a medium to be executed by a computer.

A computer-readable medium can be any usable medium which can be accessed by the computer and includes all volatile/non-volatile and removable/non-removable media. Further, the computer-readable medium may include all computer storage and communication media. The computer storage medium includes all volatile/non-volatile and removable/non-removable media embodied by a certain method or technology for storing information such as computer-readable instruction code, a data structure, a program module or other data. The communication medium typically includes the computer-readable instruction code, the data structure, the program module, or other data of a modulated data signal such as a carrier wave, or other transmission mechanism, and includes a certain information transmission medium.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

What is claimed is:

1. A security apparatus that forms a virtual security area, comprising:
a radar sensor that transmits and receives a signal; and
a reflector that reflects a signal output from another radar sensor of another security apparatus adjacent to the security apparatus,
wherein the security apparatus transmits a signal to another reflector of the another security apparatus adjacent to the security apparatus and receives a signal reflected by the another reflector of the another security apparatus through the radar sensor to form a virtual security area between the security apparatus and the another security apparatus.

2. The security apparatus of claim 1, further comprising:
a case configured to house the radar sensor and the reflector therein,
wherein the security apparatus transmits and receives the signal through at least one side surface formed of an electromagnetic wave transmitting material among a plurality of side surfaces of the case.

3. The security apparatus of claim 2,
wherein the radar sensor and the reflector are stacked and installed in a height direction of the case.

4. The security apparatus of claim 1, further comprising:
a first bracket that adjusts an angle of the radar sensor in a height direction of the security apparatus to regulate an amount of signals to be reflected by the another reflector of the another security apparatus.

5. The security apparatus of claim 4, further comprising:
a second bracket that adjusts an angle of the radar sensor in a horizontal direction of the security apparatus in order for the radar sensor of the security apparatus to be positioned to face the another reflector of the another security apparatus.

6. The security apparatus of claim 1, further comprising:
an angle adjuster that is installed on a back of the reflector to adjust an angle of the reflector in a height direction of the security apparatus.

7. The security apparatus of claim 1,
wherein the reflector has a faceted cylinder shape from which at least one side surface has been removed and is configured to receive the signal through a part with the side surface removed.

8. The security apparatus of claim 7,
wherein the reflector includes at least two reflecting members, and adjacent reflecting members among the at least two reflecting members are bonded to each other to share one edge.

9. The security apparatus of claim 8,
wherein the outermost reflecting member among the at least two reflecting members has an edge which is not shared with another reflecting member and from which a part has been removed.

10. The security apparatus of claim 1, further comprising:
a measurement unit that measures reflection data of a received signal transmitted by the radar sensor and then reflected by the reflector of the another security apparatus.

11. The security apparatus of claim 10,
wherein the measurement unit transmits the measured reflection data to a trespass detection server.

12. The security apparatus of claim 11,
wherein the trespass detection server determines whether or not an outsider has trespassed on the virtual security area formed between the security apparatus and the another security apparatus based on the measured reflection data.

13. The security apparatus of claim 10, further comprising:
an output unit that outputs a visual or auditory warning message based on the measured reflection data.

14. A security system, comprising:
a plurality of security apparatuses that forms a virtual security area,
wherein each security apparatus includes a radar sensor that transmits and receives a signal and a reflector that reflects a signal output from another radar sensor of another security apparatus adjacent to the security apparatus, and
the plurality of security apparatuses include at least a first security apparatus, a second security apparatus and a third security apparatus, and
a radar sensor of the first security apparatus transmits a signal to a reflector of the second security apparatus adjacent to the first security apparatus and receives a signal reflected by the reflector of the second security apparatus, and
a reflector of the first security apparatus receives a signal transmitted from a radar sensor of the third security apparatus adjacent to the first security apparatus and reflects the received signal to the radar sensor of the third security apparatus, and
the first security apparatus, the second security apparatus and the third security apparatus form a virtual security area among the first security apparatus, the second security apparatus and the third security apparatus by transmitting and receiving a signal.

15. The security system of claim 14,
wherein the plurality of security apparatuses are arranged at a predetermined interval around a protection area.

16. The security system of claim 15,
wherein a closed loop enclosing the protection area is formed by a plurality of virtual security areas each formed between adjacent security apparatuses among the plurality of security apparatuses.

17. The security system of claim 16,
wherein the plurality of security apparatuses further include measurement units that measure reflection data of received signals respectively transmitted by the radar sensors of the plurality of security apparatuses and then reflected by the reflectors of the plurality of security apparatuses.

18. The security system of claim 17,
wherein the plurality of security apparatuses further include determination units that determine whether or not an outsider has trespassed on the plurality of virtual security areas enclosing the protection area based on the measured reflection data.

19. The security system of claim 18,
wherein if the determination units determine that an outsider has trespassed on any one of the plurality of virtual security areas, the determination units estimate that the outsider is located between adjacent security apparatuses that form the virtual security area on which the outsider has trespassed.

20. A method for forming a virtual security area by a security apparatus including a radar sensor that transmits and receives a signal and a reflector that reflects a signal output from an external device, comprising:
transmitting a signal to another reflector of another security apparatus adjacent to the security apparatus through the radar sensor;
receiving a signal reflected by the another reflector of the another security apparatus through the radar sensor; and
forming a virtual security area between the security apparatus and the another security apparatus by transmitting and receiving the signal.
